(19) United States
(12) Patent Application Publication
(10) Pub. No.: US 2022/0252509 A1
(43) Pub. Date: Aug. 11, 2022

(54) MEASURING DEVICE AND METHOD FOR DETERMINING A SUBSTANCE CONCENTRATION

(71) Applicant: Optek-Danulat GmbH, Essen (DE)

(72) Inventors: Daniel Platte, Velbert (DE); Peter Schroeren, Kempen (DE)

(73) Assignee: Optek-Danulat GmbH, Essen (DE)

(21) Appl. No.: 17/629,991

(22) PCT Filed: Jun. 29, 2020
(86) PCT No.: PCT/EP2020/068279

§ 371 Date: Jan. 25, 2022

(30) Foreign Application Priority Data
Aug. 15, 2019 (EP) 19191934.9

(51) Int. Cl. G01N 21/33; G01N 21/31

(52) U.S. Cl. CPC G01N 21/33; G01N 21/314; G01N 2021/3125; G01N 2201/062; G01N 2021/3181; G01N 2021/3185; G01N 2021/3174

(57) ABSTRACT

A measuring device for determining a substance concentration of a fluid arranged in a measurement volume includes a source emitting a source spectrum, a wavelength-selective means arranged before the measurement volume, a measurement space limiting the measurement volume at least in a beam path, and a detector for measuring a wavelength-related absorption of a measurement spectrum having passes through the measurement volume. A fluorescence-reducing element is arranged in the beam path between the detector and the measurement volume. A beam splitter is arranged between the source and the measurement volume.

### FIELD OF THE INVENTION

The present invention relates to a measuring device for determining a substance concentration of a fluid arranged in a measurement volume and a corresponding method.

### BACKGROUND OF THE INVENTION

In the process control and the quality assurance of products, generic measuring devices and methods play a major role both on the laboratory scale and also on the process scale. The measurement accuracy in as large a range as possible of the concentration of the substance to be measured is important. An equally important role is played by the fact that the measurement accuracy is maintained over a long measurement period, so that a calibration of the measuring device is required as rarely as possible or not at all.

In biotechnology, absorption measurements are used primarily to determine the concentration of nucleic acids and for determining the protein concentration or the concentration of amino acids. The latter is used for example in the chromatographic separation of protein solutions.

Product flows in particular arise, in which the substance to be determined is contained in different concentrations at different times. By means of the absorption measurement, a selection with regard to the concentration and/or impurities for example is controlled on the basis of the measurement results.

A measurement range that is as wide and dynamic as possible is therefore required for the measuring device, as a rule a process photometer. Moreover, good reproducibility of the measurements and good comparability of different measurement points are preferable. In order to obtain meaningful measurement results, the error estimations whereof produce the narrowest possible tolerance ranges, it is desirable, aside from the good reproducibility and independence from interfering influences, also to have good comparability of the measurements in the process with those on the laboratory scale and in particular good linearity between the substance concentration and the absorption.

It is also advantageous if, instead of the substance actually to be measured, a replacement substance can be used for the purposes of device calibration. This is particularly advantageous when the substance to be measured is costly, has a poor stability or is generally difficult to handle.

The problem of the present invention, therefore, is to specify a measuring device and a method for determining a substance concentration, which enables a measurement which is as accurate as possible and is as reproducible as possible in the long-term.

The aforementioned technical problems are solved in particular with a measuring device and/or a method described herein. Advantageous developments of the invention are given herein.

### SUMMARY OF THE INVENTION

All combinations of at least two features given in the description, the claims and/or the figures also fall within the scope of the invention. In stated value ranges, values lying inside the stated limits are also deemed to be disclosed as limiting values and can be claimed in any combination.

The idea underlying the invention is to minimise undesired influences of a source spectrum on the measurement/determination of the substance concentration. According to the invention, this takes place in particular by arranging a fluorescence-reducing element in the beam path, preferably between the detector and the measurement volume, and by limiting the irradiation into the measurement volume, in particular radiation with a wavelength diverging with respect to the measurement wavelength, preferably shorter-wave radiation. The measuring device according to the invention and the method according to the invention, therefore, are preferably used with fluids which respond in a fluorescent manner to the, in particular narrow-band, source spectrum and/or the measurement wavelength.

Measurement wavelength and measurement wavelength range are used below as alternative designations, but should in each case relate to both. According to the invention, the spectrum that is regarded as the measurement spectrum is one which arrives at a detector without being influenced by the substance to be measured in the measurement volume.

In particular, a plurality of measurement wavelengths can be detected by the detector. A plurality of detectors can also be used for the detection of the at least one measurement wavelength.

According to the invention, at least one beam splitter is arranged between the source and the measurement volume. The latter is constituted in particular as a partially reflecting layer or a fully reflecting layer or wavelength-sensitive. In particular, a wavelength-sensitive beam splitter can also perform the function of fluorescence reduction.

A beam splitter is an optical component which splits a light beam into two partial beams. A very simple beam splitter is for example a glass pane, which is introduced into the beam path at an angle of 45°. A part of the light is reflected at the surface of the pane at an angle of 90°, a further part penetrates the pane. By applying a suitable partially reflecting coating on the surface of the pane, the beam can thus be split into two beams of the same intensity (semi-permeable mirror).

In particular, the beam splitter comprises two prisms, which are joined together at their base (for example with Canada balsam). The principal according to which a beam splitter cube functions is the impeded total reflection. The splitting ratio is thus dependent on the wavelength of the light.

Apart from non-polarising beam splitters, there are also polarising beam splitters (also referred to as a pole cube). The splitting ratio is determined here by the polarisation angle of the incident light.

A plurality of measurement wavelengths preferably use the same beam path and the same detector, wherein the different measurement wavelengths penetrate the measurement volume time-interlaced. In particular, the different measurement wavelengths penetrate the measurement volume at different points (e.g. exit of a plurality of optical waveguides).

Flexible optical waveguides are preferably used, but rigid optical waveguides, in particular linear arrangements, are also possible.

If a plurality of measurement wavelengths are used, the path lengths in the measurement volume are preferably of equal length.

The power irradiated into the measurement volume can in particular be modulated, e.g. by mechanical (chopper, chopper mirror), electro-optical (liquid crystal arrangements, Pockles cells), electro-mechanical and/or electrical means (operating current of the source (LED)). The modulation scheme can be deterministic, partially random or pseudorandom. This relates to both individual measurement lengths and also to the intensity sequence of different wavelengths.

The intensity of the measurement radiation between the source and the measurement volume can preferably be measured intermittently or continuously, in particular while the measurement wavelength is detected in the measurement detector. Depending on the measured intensity, the source intensity can be controlled to a predefined value (fixed or variable over time (modulation)), wherein the measured values can be standardised depending on setpoint values and/or the measured values.

At least some of the components of the measuring device are preferably arranged spatially separated from one another, in such a way as to control an interaction with the environment, to prevent, at least to reduce, temperature influences of the process medium on the measuring technique, temperature influences of the measuring technique on the medium and electromechanical influences on sensitive detector circuits, and to separate ignition sources from a potentially explosive atmosphere.

According to the invention, an optical determination, in particular with electromagnetic radiation in the measurement wavelength range between 100 nm and 5 μm, is preferred. According to Lambert-Beer's law, the (decadic) logarithm of the quotient of the transmitted (Lt) and irradiated (L0) luminous power at a given layer thickness D is proportional at each wavelength to the substance concentration c (in particular particle number per volume, for example mol/l):

A (Lambda)=log10(L0/Lt)=k*c*D

Proportionality constant k is referred to below as the absorption coefficient. The connection represented in the above equation applies to almost all substances over a broad concentration range. By using logarithmically scaled ratio A, a linear connection between this magnitude and substance-dependent absorption coefficient k, substance concentration c and layer thickness D results. The connection applies in particular when irradiated and transmitted light have the same wavelength and no scatter of the light in the measurement volume occurs. The practical measurement of A requires that the entire optical radiation covers an approximately equal distance in the measurement volume. According to the invention, therefore, it is preferable if the measurement volume is limited in the beam path direction by plane-parallel windows and/or a measurement beam emitted by a measurement source runs approximately parallel, i.e. in particular not scattering.

The present invention is based in particular on the knowledge that, in the case of substances with fluorescent properties contained in the fluid to be measured temporally changing interfering influences on the measurement spectrum in particular result. In a determination, preferred according to the invention, of a substance concentration of proteins containing tryptophan, an extended fluorescence light with a maximum at approx. 350 nm arises with a measurement wavelength of 280 nm.

As a result, interference in the detection and thus interference in the determination of the substance concentration can occur.

The described effect can be more noticeably observed primarily with high concentrations and/or larger layer thicknesses, especially with weakening of the light at the measurement wavelength by more than two orders of magnitude. Furthermore, the fluorescence yield depends on the temperature and environment of the molecule and can be disturbed by other substances. Deviations from the linearity of the measurement thus occur at different concentrations, so that the measurement results are less reproducible and scalable.

The essence of the present invention, therefore, is in particular the measurement of the spectral absorption for determining a substance concentration, wherein wavelength-selective means/components are arranged in the beam path both before and also after the measurement volume.

Wavelength-selective means/components are especially characterised according to the invention by the fact that they cause radiation of the source spectrum in undesired wavelength ranges, i.e. in particular outside the measurement wavelength, to be more markedly reduced than in the desired wavelength range.

Wavelength-selective means are arranged on the irradiation side, i.e. in the beam path before the measurement volume, as a result of which harmful radiation of the source spectrum, in particular in a range which is shortwave compared to the measurement wavelength, is reduced. As a result of this measure according to the invention, the fluid arranged in the measurement volume is exposed as little as possible to radiation.

As result of the wavelength-selective means arranged in the beam path after the measurement volume, fluorescent light, in particular induced by the measurement wavelength in the measurement volume, is reduced/absorbed, in order to ensure a linear and reproducible measurement over a wide range of the substance concentration.

The wavelength-selective means arranged behind the measurement volume can in particular be a fluorescence-reducing element. The fluorescence-reducing element is preferably an interference filter with more than 10% transmission, in particular more than 20% transmission, preferably more than 30% transmission of a centre wavelength of 280 nm and a half width of at most 40 nm, preferably at most 20 nm, still more preferably between 9 and 15 nm.

As a result of the wavelength-selective means arranged before and after the measurement volume and/or further wavelength-selective means/components, the source spectrum is concentrated on the measurement wavelength, i.e. preferably has a maximum at the measurement wavelength. A measurement wavelength is preferred at which the absorption of the substance concentration of the substance to be measured is as high as possible, in particular has a local maximum.

The further wavelength-selective means/components can be constituted in particular by the formation of the source as a narrow-band light source and/or an additional filter arranged in the beam path, preferably located after the measurement volume.

The spectral distribution of the measured radiation is preferably determined essentially by the wavelength-selective means arranged before the measurement volume, in particular a monochromator with a measurement wavelength of 280 nm and a half width of at most 5 nm.

According to an advantageous embodiment of the present invention, the intensity of the measured radiation is reduced by the wavelength-selective means arranged after the measurement volume by at most a factor of 10, preferably at most by a factor of 5. The fluorescent light, on the other hand, is preferably reduced by at least a factor of 20, preferably by at least a factor of 50, still more preferably by at least a factor of 100.

A preferred wavelength-selective means according to the invention for the wavelength selection before the measurement volume is a source emitting in particular a narrow-band source spectrum. The wavelength selection can take place by providing a narrow-band light source, in particular one or more of the light sources mentioned below:

LEDs,

low-pressure gas discharge lamps,

laser, preferably tunable.

Alternatively, the source can comprise a broad-band light source with a downstream lightwave-selective intermediate element, in particular one of the following:

at least one diffraction grid and/or

at least one interference filter.

According to the invention, the following in particular come into question as a broad-band source:

incandescent lamps,

plasma sources,

gas discharge lamps.

According to an embodiment of the present invention, it is conceivable to provide a combination of line sources with additional wavelength-determining elements. The optical elements are in particular arranged discretely behind one another. Alternatively or in addition, it is in particular conceivable to bring about a spatial separation and to guide the optical radiation (source spectrum) between individual components via light guide elements, in particular optical fibres, lens lines and/or lines with gradient index lenses.

According to a further advantageous embodiment of the present invention, the measuring device for determining the absorption can be standardised or is standardised to the intensity irradiated into the measurement volume. In particular, this takes place by the measurement volume being filled with a non-absorbent reference fluid, in order to pick up one or more reference value(s) for the measurement spectrum.

According to a further advantageous embodiment of the invention, it is conceivable to monitor the irradiated intensity in time intervals or continuously, in order to be able to take account of temporal changes in the irradiated intensity. This can take place in particular by diverting the source spectrum, in particular by a chopper mirror.

The downstream wavelength-selective component according to the invention is preferably a fluorescence-reducing element. A filter is preferably used, which influences the measurement wavelength to be measured by the detector much less compared to the measurement wavelength of long wave radiation. The fluorescence-reducing element preferably has at the measurement wavelength an absorption of less than 50%, more preferably less than 20%. The fluorescence-reducing element has, on the other hand, an absorption as high as possible in the wavelength range in which a fluorescence emission would be induced. According to the invention, moreover, it is conceivable to arrange in the beam path a plurality of measurement wavelengths and a plurality of ranges for the fluorescence reduction and/or an element with a tunable pass-band.

According to a further advantageous embodiment of the invention, at least one wavelength-selective component, in particular the fluorescence-reducing element, is constituted as a component limiting the measurement volume along the beam path.

Alternatively or in addition, the fluorescence-reducing element is equipped in particular with a radiation direction-selective element. Fluorescence radiation is at least largely reduced in this way via the use of the different angular distribution, whilst the radiation to be measured at least largely passes through the fluorescence-reducing element unchanged and can be measured, without the measurement at the detector being significantly influenced by fluorescence radiation. According to the invention, this can be solved in particular by an optical spatial filter.

According to a preferred embodiment of the present invention, the detector for measuring the wavelength-related absorption of the source spectrum emitted by the source and having passed through the measurement volume converts, by means of an electrical current measurement, the measurement spectrum striking the detector into a photo-current. For this purpose, use is made in particular of a photomultiplier, a photodiode semiconductor and/or a vacuum tube. Alternatively, holometric methods are conceivable, since a measurement spectrum wavelength-selected to the measurement wavelength strikes the detector.

A bolometer can in particular be used as a detector.

According to the invention, the measurement wavelength is regarded in particular as the wavelength which is registered by a detector by taking the arithmetical mean of the wavelength, preferably weighted with the respective radiation intensity, with negligible absorption of a target substance (the substance concentration of which is measured), in particular without the possibility of further wavelength selection.

According to the invention, the measurement wavelength lies in particular between 200 nm and 15 μm, preferably between 250 nm and 320 nm, still more preferably at 280 nm +/−5 nm and/or 260 nm +/−5 nm and/or 254 nm +/−5 nm, still more preferably at 280 nm +/−0.1 nm.

According to the invention, the distance measured in the wavelength between the points in the intensity spectrum is in particular regarded as the half width, at which the intensity of the measurement radiation of the measurement spectrum has fallen to half its maximum value. According to the invention, the half width amounts in particular to at most 1/5 of the measurement wavelength, preferably at most 1/10 of the measurement wavelength, still more preferably at most 1/50 of the measurement wavelength.

According to the invention, the thousandth of the width of the measurement radiation is the distance measured in the wavelength between the points in the intensity spectrum at which the intensity of the measurement radiation of the measurement spectrum has fallen to a thousandth of its maximum value. According to the invention, a thousandth of the width amounts in particular to at most half the measurement wavelength, preferably at most a quarter of the measurement wavelength.

According to an advantageous embodiment of the invention, means are provided for the reduction of the shortwave and/or longwave radiation to the measurement wavelength by at least a factor of 2, preferably by at least a factor of 10, still more preferably by at least a factor of 100, related to the irradiated power density of the measurement wavelength before entry into the measurement volume.

According to the invention, a wavelength selection takes place between the measurement volume and the detector, wherein the source spectrum is limited to the measurement wavelength, in particular at least longwave, preferably with a fall by at least a factor of 2, preferably by at least a factor of 10, still more preferably by at least a factor of 100, related to the measurement wavelength. The fall takes place in particular in a vicinity around the measurement wavelength, which amounts in particular to 50/100, preferably 2/100.

Features disclosed according to the device should also be deemed, as process features, to be disclosed as an independent or combined invention and vice versa. Further advantages, features and details of the invention emerge from the following description of preferred examples of embodiment and on the basis of the drawings.

### BRIEF DESCRIPTION OF THE DRAWINGS

FIG. 1 shows a diagrammatic, perspective representation of a first embodiment of a measuring device according to the invention; and

FIG. 2 shows a diagrammatic, perspective representation of a second embodiment of the measuring device according to the invention.

Identical and identically functioning components/features are denoted in the figures with the same reference numbers.

### DETAILED DESCRIPTION OF THE INVENTION

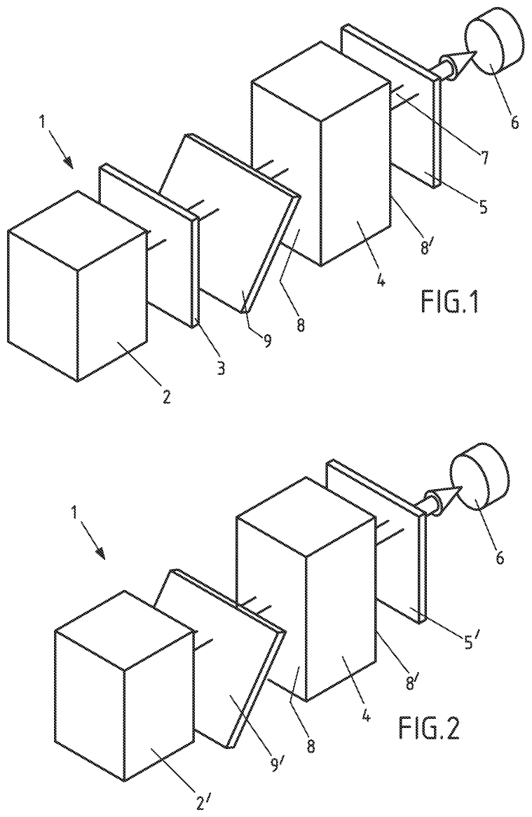

A source 1 is represented in FIG. 1, which is formed from a light source 2 and a wavelength-selective optical element 3. Light source 2 is constituted as a broadband light source, which emits a broadband source spectrum with a beam path 7, which runs in particular linearly up to a detector 6.

A beam splitter 9 is arranged between source 1 and measurement volume 4, wherein beam splitter 9 is arranged between optical element 3 of source 1 and measurement volume 4. Beam splitter 4 splits the incoming light beam into a first partial beam, which continues to run along beam path 7, and a second partial beam (not represented), which continues to run in another direction. This second partial beam can run at right angles to beam path 7 and in particular strike a reference detector (not represented), by means of which the second partial beam is evaluated.

The broadband source spectrum of light source 2 strikes wavelength-selective optical element 3 and, when it passes through wavelength-selective optical element 3, radiant power is markedly reduced in shortwave to a measurement wavelength of 280 nm. Wavelength-selective element 3 leaves a narrow-band source spectrum with a predominant power density in a wavelength range of over 250 nm. Over 90% of the irradiated power density is preferably in this range.

The narrow-band source spectrum limited at least below the measurement wavelength strikes a measurement volume 4 along beam path 7. Measurement volume 4 is limited by a measurement space, which at least in the direction of beam path 7 comprises windows 8, 8′ arranged transversely to beam path 7. Windows 8, 8′ are preferably arranged orthogonal to beam path 7 and preferably have a defined distance along beam path 7. The distance corresponds to the layer thickness through which the narrow-band spectrum passes along beam path 7 through a fluid arranged in the measurement volume.

The fluid is arranged either statically in measurement volume 4 or flowing transversely to beam path 7.

The fluid has a substance concentration of a substance (target substance) to be determined, preferably tryptophan, which gives rise to a change measurable by detector 6 in the narrow-band source spectrum in the measurement wavelength range passing through measurement volume 4.

The narrow-band source spectrum can produce fluorescence generated in particular by the target substance, which fluorescence can lead, amongst other things along beam path 7, to a falsification of the signals to be measured by detector 6, in particular in a spectrum with a wavelength above the measurement wavelength.

For this reason, a further wavelength-selective optical element in the form of a fluorescence-reducing element 5 is arranged in the beam path behind measurement volume 4 in the beam path direction. During the passage of the narrow-band source spectrum passing through measurement volume 4, any fluorescence radiation generated in measurement volume 4 is at least predominantly, preferably largely, still more preferably completely absorbed. The narrow-band spectrum, in particular limited in shortwave and longwave and provided for the measurement of the substance concentration, thus at least predominantly, preferably virtually exclusively strikes detector 6, said spectrum having its power density at least predominantly in the measurement wavelength range. The measurement spectrum preferably has a maximum of the power density at the measurement wavelength.

Fluorescence-reducing element 5 is preferably selective at 280 nm +/−5 nm and/or 260 nm +/−5 nm and/or 254 nm +/−5 nm.

Detector 6 measures the light having passed out of measurement volume 4 and through fluorescence-reducing element 5 by conversion into a photoflow by means of an electrical current measurement, in particular a photomultiplier. Conclusions can be drawn from this regarding the substance concentration of the target substance.

The embodiment shown in FIG. 2 differs from the embodiment described in FIG. 1 in that a narrow-band light source 2′ is provided as source 1, so that a wavelength-selective optical element 3 can be dispensed with in this embodiment. Light source 2′ already emits a source spectrum at least predominantly radiating in the measurement wavelength range and thus comprises wavelength-selective means arranged before measurement volume 4.

A beam splitter 9′ is arranged between source 1 and measurement volume 4, wherein beam splitter 9′ is arranged between light source 2′ and measurement volume 4. Beam splitter 4 splits the incoming light beam into a first partial beam, which continues to run along beam path 7, and a second partial beam (not represented), which continues to run in another direction. This second partial beam can run at right angles to beam path 7 and in particular strike a reference detector (not represented), by means of which the second partial beam is evaluated.

Fluorescence-reducing element 5′ in this embodiment is preferably at least predominantly, preferably virtually exclusively selective for longwave to the measurement wavelength.

### LIST OF REFERENCE NUMBERS

1 source
2, 2′ light source
3 wavelength-selective optical element
4 measurement volume
5, 5′ fluorescence-reducing element
6 detector
7 beam path
8, 8′ window
9, 9′ beam splitter

1.-8. (canceled)

9. A measuring device for determining a substance concentration of a fluid arranged in a measurement volume, comprising:
a source emitting a source spectrum;
a wavelength-selective means arranged before the measurement volume;
a measurement space limiting the measurement volume at least in a beam path; and
a detector for measuring a wavelength-related absorption of a measurement spectrum having passed through the measurement volume,
wherein a fluorescence-reducing element is arranged in the beam path between the detector and the measurement volume, and
wherein a beam splitter is arranged between the source and the measurement volume.

10. The measuring device according to claim 9, wherein the fluorescence-reducing element is designed to at least predominately absorb fluorescence.

11. The measuring device according to claim 9, wherein the fluorescence-reducing element is configured to reduce an intensity of a measurement wavelength radiation in a measurement wavelength range by at most a factor of 10.

12. The measuring device according to claim 9, wherein the fluorescence-reducing element comprises one or more filters, a monochromator, or a combination thereof.

13. The measuring device according to claim 9, wherein the source is a narrow-band light source or a broadband-light source with a downstream wavelength-selective optical element.

14. The measuring device according to claim 9, wherein the measuring device is designed to measure a measurement spectrum between 200 nm and 15 μm.

15. The measuring device according to claim 9, wherein the detector is designed to measure a measurement wavelength between 200 nm and 15 μm.

16. The measuring device according to claim 9, wherein the fluorescence-reducing element is designed to almost completely absorb fluorescence.

17. The measuring device according to claim 9, wherein he fluorescence-reducing element is designed to reduce the intensity of the measurement wavelength radiation in the measurement wavelength range by at most a factor of 5.

18. The measuring device according to claim 12, wherein the filters are arranged on a filter wheel.

19. The measuring device according to claim 9, wherein the measuring device is designed to measure a measurement spectrum between 250 nm and 320 nm.

20. The measuring device according to claim 9, wherein the measuring device is designed to measure a measurement spectrum of 280 nm +/−5 nm, 260 nm +/−5 nm, 254 nm +/−5 nm, or one more combinations thereof.

21. The measuring device according to claim 9, wherein the detector is designed to measure a measurement wavelength between 250 nm and 320 nm.

22. The measuring device according to claim 9, wherein the detector is designed to measure a measurement spectrum of 280 nm +/−5 nm, 260 nm +/−5 nm, 254 nm +/−5 nm, or one more combinations thereof.

23. A method for determining a substance concentration of a fluid arranged in a measurement volume, comprising:
outputting a source spectrum with a beam path running at least partially through the measurement volume; and
measurement of a wavelength-related absorption of a measurement spectrum having passed through the measurement volume by means of a detector,
wherein wavelength-selective means are provided before the measurement volume,
wherein fluorescence in the beam path is reduced between the detector and the measurement volume, and
wherein a beam splitter is arranged between the source and the measurement volume.
